(19) United States
(12) Patent Application Publication
(10) Pub. No.: US 2023/0405929 A1
(43) Pub. Date: Dec. 21, 2023

(54) APPARATUS, SYSTEM AND METHOD FOR DIGITALLY MASKED PRINT AREA HEATING

(71) Applicant: JABIL INC., St. Petersburg, FL (US)

(72) Inventors: Scott Klimczak, St. Petersburg, FL (US); Luke Rodgers, St. Petersburg, FL (US); Darin Burgess, St. Petersburg, FL (US)

(21) Appl. No.: 18/461,220

(22) Filed: Sep. 5, 2023

Related U.S. Application Data
(63) Continuation of application No. 17/417,044, filed on Jun. 21, 2021.
(60) Provisional application No. 62/782,045, filed on Dec. 19, 2018.

(51) Int. Cl. B29C 64/286; B29C 64/295; B29C 64/209; B29C 64/35

(52) U.S. Cl. CPC B29C 64/286; B29C 64/295; B29C 64/209; B29C 64/35; B33Y 30/00

(57) ABSTRACT

The disclosure is of and includes at least an apparatus, system and method for an additive manufacturing system. The apparatus, system and method may include at least: a heated print nozzle suitable to deliver at least partially liquefied print material to a print build in a print area; at least two projected digital masks suitable for providing a pixelization masking of the print area; and at least one print area heater suitable to deliver heat to ones of the masked pixels in the print area responsive to at least one controller.

### CROSS-REFERENCE TO RELATED APPLICATIONS

The present application is a Continuation Application of U.S. patent application Ser. No. 17/417,044, filed Jun. 21, 2021, entitled: “Apparatus, System and Method for Digitally Masked Print Area Heating,” which claims benefit to International Application PCT/US2019/066959, filed Dec. 17, 2019, entitled: “Apparatus, System and Method for Digitally Masked Print Area Heating,” which claims priority to U.S. Provisional Application No. 62/782,045, filed Dec. 19, 2018, entitled: “Apparatus, System and Method for Digitally Masked Print Area Heating,” the entirety of which is incorporated herein by reference as if set forth in its entirety.

### BACKGROUND

### Field of the Disclosure

The present disclosure relates to additive manufacturing, and, more specifically, to an apparatus, system and method for digitally masked print area heating in an additive manufacturing system.

### Description of the Background

Additive manufacturing, including three dimensional printing, has constituted a very significant advance in the development of not only printing technologies, but also of product research and development capabilities, prototyping capabilities, and experimental capabilities, by way of example. Of available additive manufacturing (collectively “3D printing”) technologies, fused deposition of material (“FDM”) printing is one of the most significant types of 3D printing that has been developed.

FDM is an additive manufacturing technology that allows for the creation of 3D elements on a layer-by-layer basis, starting with the base, or bottom, layer of a printed element and printing to the top, or last, layer via the use of, for example, heating and extruding thermoplastic filaments into the successive layers. Simplistically stated, an FDM system includes a print head which feeds the print material filament through a heated nozzle to print, an X-Y planar control for moving the print head in the X-Y plane, and a print platform upon which the base is printed and which moves in the Z-axis as successive layers are printed.

More particularly, the FDM printer nozzle heats the thermoplastic print filament received to a semi-liquid state, and deposits the semi-liquid thermoplastic in variably sized beads along the X-Y planar extrusion path plan provided for the building of each successive layer of the element. The printed bead/trace size may vary based on the part, or aspect of the part, then-being printed. Further, if structural support for an aspect of a part is needed, the trace printed by the FDM printer may include removable material to act as a sort of scaffolding to support the aspect of the part for which support is needed. Accordingly, FDM may be used to build simple or complex geometries for experimental or functional parts, such as for use in prototyping, low volume production, manufacturing aids, and the like.

However, the use of FDM in broader applications, such as medium to high volume production, is severely limited due to a number of factors affecting FDM, and in particular affecting the printing speed, quality, and efficiency for the FDM process. As referenced, in FDM printing it is typical that a thermoplastic is extruded, and is heated and pushed outwardly from a heating nozzle, under the control of the X-Y and/or Z driver of a print head, onto either a print plate/platform or a previous layer of the part being produced. More specifically, the nozzle is moved about by the robotic X-Y planar adjustment of the print head in accordance with a pre-entered geometry, such as may be entered into a processor as a print plan to control the robotic movements to form the part desired.

This additive manufacturing printing via X-Y movement and Z-axis layering often is performed using high temperature filaments, or filaments having a high shrink rate when cooled, which require the area of the printing environment, i.e., the print area onto which the layers are formed, to be heated. This elevated printing environment temperature may also aid in the intra- and inter-layer adhesion for the layers printed in the X, Y and Z-Axis.

In aspects of the known art, this work environment temperature may be controlled using horizontal heat flow, such as may be applied from two sides of the print environment. However, in such cases the surfaces are areas that are directly exposed to the heat flow are warmer than other areas of the print environment, such as the internal areas or non-heat facing sides of the print. That is, the outer geometry of the print and the print environment is thus warmer than the internal geometry.

Moreover, different levels and types of heating in additive manufacturing is needed for different print geometries. For example, if a print geometry overhangs, the heat from the environment combined with the heat of material being printed may cause the printed part to droop. Consequently, as large solid parts have a greater temperature deviation from the inside to the outside, the likelihood of a substandard print is heightened for such parts using known print environment heating methodologies.

### SUMMARY

The disclosure is of and includes at least an apparatus, system and method for an additive manufacturing system. The apparatus, system and method may include at least: a heated print nozzle suitable to deliver at least partially liquefied print material to a print build in a print area; at least two projected digital masks suitable for providing a pixelization masking of the print area; and at least one print area heater suitable to deliver heat to on of the masked pixels in the print area responsive to at least one controller.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 is an illustration of an additive manufacturing printer;

FIG. 2 is an illustration of an exemplary additive manufacturing system;

FIG. 3 illustrates a digitally masked print environment;

FIG. 4 illustrates a digitally masked print environment; and

FIG. 5 illustrates an exemplary computing system.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

The embodiments provide a digitally masked energy device and system to heat an additive manufacturing print environment. The digital mask may grayscale pixelized heat to the areas to be printed.

More specifically, each of the “pixels” representing the print image may be stored in association with the control system 1100 and print algorithm 1190 discussed throughout. More specifically, each pixel value may describe the extent of an “on” or “off” state of the area represented by that pixel; that is, whether the area encompassed by that pixel is heated or not, and, if heated, how heated.

Pixelization in the control algorithm may be “grayscaled”, as referenced above, wherein the pixel may be a “gray” value between “black” (i.e., “heat fully off”), and white (i.e., “heat fully on”), to represent the heating in, or needed in, the print area corresponded to that pixel. Of course, the foregoing grayscale is provided herein be way of example only, and other pixel scales, such as vectored scales or the like, may be used by the control algorithm. Further, the storage of control system 1100 may include, by way of example, actual pixel values or indexed values. That is, pixelization allows for the causation of, and/or the monitoring of to maintain, a different temperature(s) for each pixelized portion of the print area.

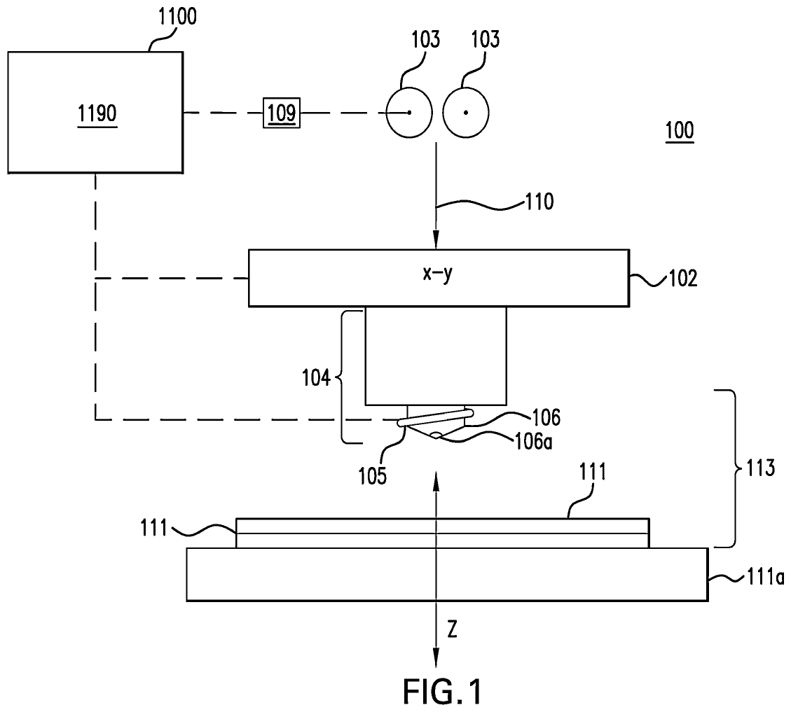

FIG. 1 is a block diagram illustrating an exemplary filament-based printer 100. In the illustration, the printer includes an X-Y axis driver 102 suitable to move the print head 104, and thus the print nozzle 106 on the print head 104 and associated with heater 105, in a two dimensional plane, i.e., along the X and Y axes. Further included in the printer 100 for additive manufacturing are the aforementioned print head 104, including print nozzle 106. As is evident from FIG. 1, printing may occur upon the flow of heated print material outwardly from the nozzle 106 along a Z axis with respect to the X-Y planar movement of the X-Y driver 102. Thereby, layers of printed material 110 may be provided from the nozzle 106 onto the print build plate 111a/print build 111 within print environment 113 along a path dictated by the X-Y driver 102.

More particularly, filament-based 3D printers include an extruding print head 104 that uses the hobs 103 to move the filament 110 into the heated nozzle 106 at a feed rate tied to the controller 1100 executing the print plan algorithm 1190 via the X-Y-Z axis driver 102. A motor 109 is generally used to drive a driven one of the hobs 103 against an undriven one of the hobs 103.

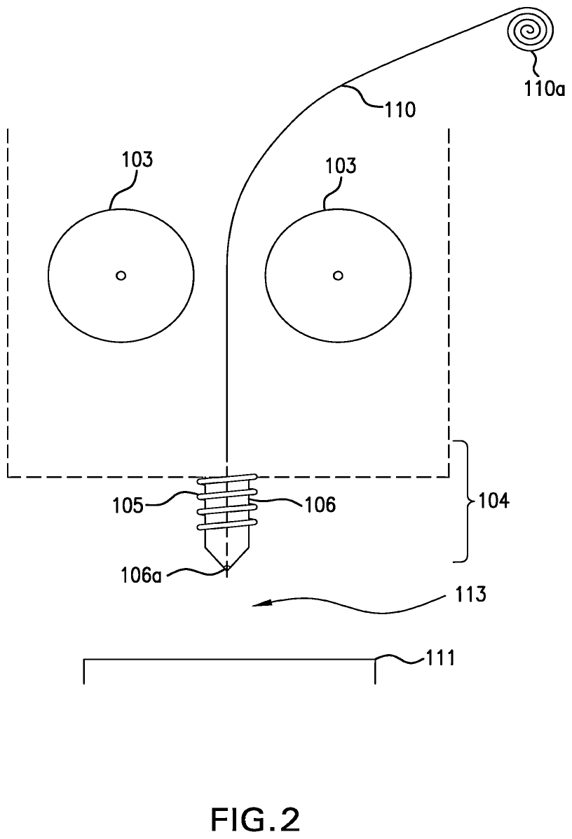

FIG. 2 illustrates with greater particularity a print head 104 having nozzle 106 for an exemplary additive manufacturing device, such as a 3-D printer, such as a FDM printer. As illustrated, the print material 110 is extruded via hobs 103 of the head 104 from a spool of print material 110a into and through the heated nozzle 106. As the nozzle 106 heats the print material 110, the print material is at least partially liquefied for output from an end port 106a of the nozzle at a point along the nozzle distal from the print head 104 onto the print build 111 in print area 113. Thereby, the extruded material is “printed” outwardly from the port 106a via the Z axis along a X-Y planar path determined by the X-Y driver (see FIG. 1) connectively associated with the print head 104.

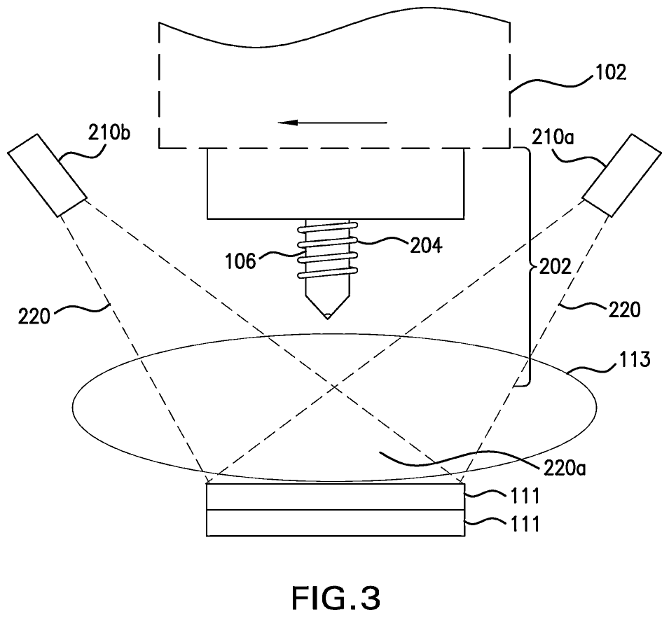

As shown in FIG. 3, the “hot end” 202, including at least a heater 204 and a nozzle 106, may be provided with two projectors 210a, b, such as two mini digital light processing digital light processing projectors, having fields of view overlapping a print area 113 around and beneath at least the nozzle 106. A digital light processing is a display device that uses digital micromirrors.

Two projectors 210a, b may be provided to avoid “blind spots” in the print area 113 that may occur due to shadowing from the nozzle 106, such as if the nozzle 106 were to move in a direction directly opposite of one of the projectors 210a. The area of overlap 220a between the fields of view 220 of each of the two projectors 210a,b may be minimized, such as to minimize power consumption, optimize processing, and to enable delivery of energy at a high rate.

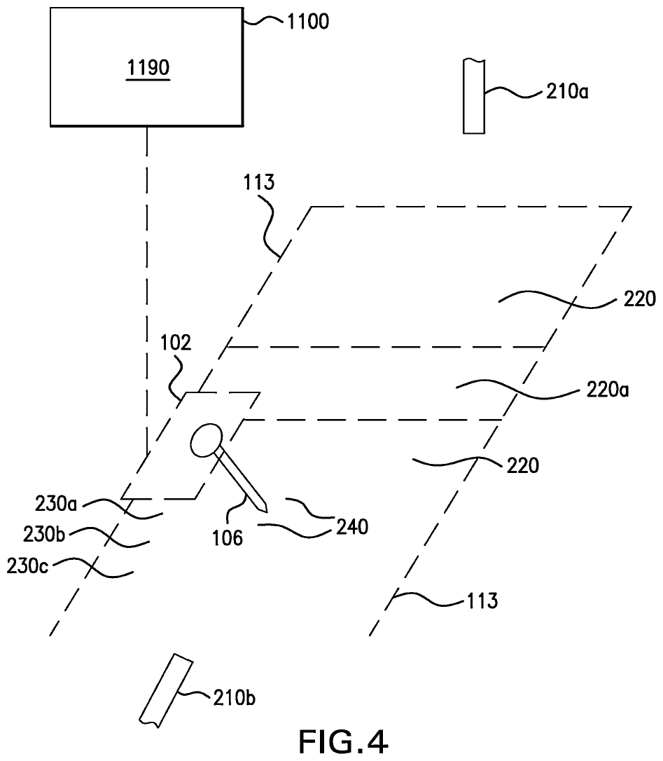

FIG. 4 is a top view illustration of a print area 113 that includes the nozzle 106 and an area 220 projected by two digital light processing projectors 210a, b. As shown, the digital light processing area 220 may be pixelized 230a, b, c, . . . , such that heating can be targeted and/or monitored with particularity by control system 1100 in each portion of the print area 113 represented by each pixel 230a, b, . . . . Accordingly, print area heat 240 can be delivered, as needed or anticipatorily based on knowledge of the print plan within control algorithm 1190, in a targeted manner to one or more pixelized portions 230a, b . . . of the print area 113. Further, the digital light processing projection areas 220 may include overlap 220a, such as to avoid the shadowing issues discussed herein. Of note, in embodiments, the overlap 220a may be substantially centered about the nozzle tip 106a.

The pixelized heat energy 240 may be provided to the print area 113 for any of a variety of reasons known to the skilled artisan. For example, pixelized heat energy 240 may be provided to preheat certain areas of a printed layer 111 in anticipation of the delivery to those areas of print feed material 110, such as to thereby improve the intra- and inter-layer bonding during a print build 111. That is, the embodiments may improve side-to-side feature print bonding, as well as “z-axis” print layer bonding. The targeted heat 240 may be provided via any methodology known to the skilled artisan, such as by using collimation, lasers, heat lenses, and the like.

The pixelized heat energy 240 may be corresponded to the baseline temperature of the print area, such as inclusive of layer-by-layer variations of the baseline temperature, by the controller 1100. Likewise, the pixelized heat energy 240 may be corresponded by controller 1100 with the heated nozzle temperature as indicated by print plan 1190.

As such, the embodiments may at least partially eliminate the need to warm the entire working print environment, and may work in conjunction with the known heated working print environment. By way of non-limiting example, the work environment 113 may be maintained by the control algorithm(s) 1190 at a particular base line temperature optimized for the existing printed layers 111a (which temperature may vary as each layer is printed), and the disclosed digital heat mask(s) 220 may allow for the refining of the temperature, per pixelized portion of the print area, along the working print build plane.

Of course, the ability to localize heat from above per mask(s) 220, the environmental temperature of a broader area or areas in the work environment may be maintained to optimize the print operation. By way of example, the energy delivered by the digital mask 220 may focus on the Z layer of the build 111, or on side-to-side layer bonding.

Accordingly, the embodiments provide a precision pixel-based thermal control of an additive manufacturing print build area using digitally masked targeted heating. This pixelized thermal control may be provided nearer the print head, such as ahead of the area being printed, on pre-printed layers at the lower portion of the print area, and so on. In sum, a pixelized level of process control may thus be provided during additive manufacturing printing directly where such control is needed.

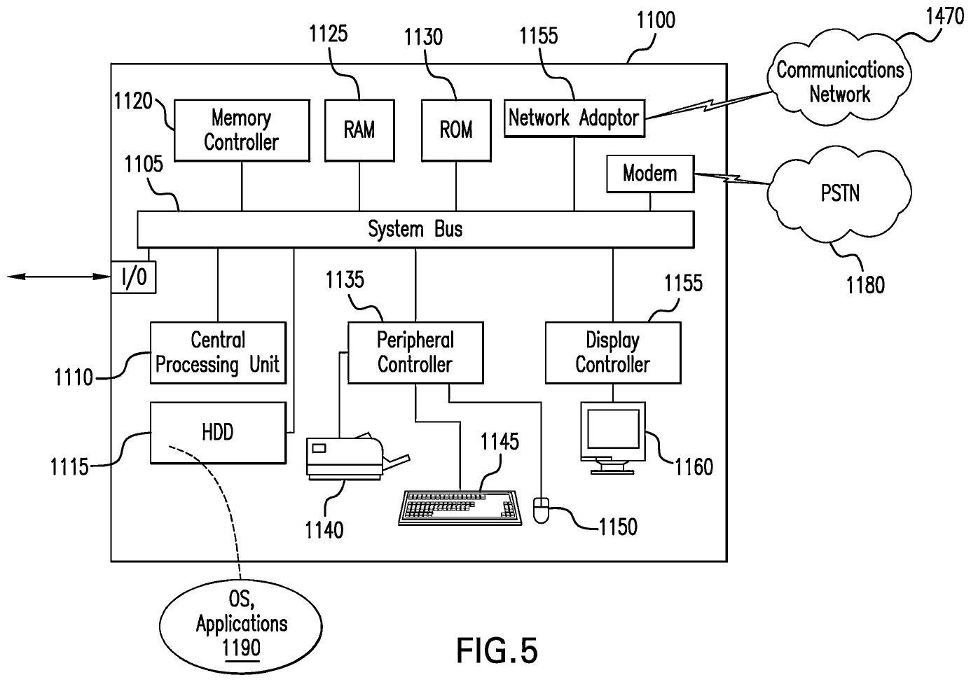

FIG. 5 depicts an exemplary computing system 1100 for use as the controller 1100 in association with the herein described systems and methods. Computing system 1100 is capable of executing software, such as an operating system (OS) and/or one or more computing applications/algorithms 1190, such as applications/algorithms applying the print plan and control algorithms discussed herein.

The operation of exemplary computing system 1100 is controlled primarily by computer readable instructions, such as instructions stored in a computer readable storage medium, such as hard disk drive (HDD) 1115, optical disk (not shown) such as a CD or DVD, solid state drive (not shown) such as a USB “thumb drive,” or the like. Such instructions may be executed within central processing unit (CPU) 1110 to cause computing system 1100 to perform the operations discussed throughout. In many known computer servers, workstations, personal computers, and the like, CPU 1110 is implemented in an integrated circuit called a processor.

It is appreciated that, although exemplary computing system 1100 is shown to comprise a single CPU 1110, such description is merely illustrative, as computing system 1100 may comprise a plurality of CPUs 1110. Additionally, computing system 1100 may exploit the resources of remote CPUs (not shown), for example, through communications network 1170 or some other data communications means.

In operation, CPU 1110 fetches, decodes, and executes instructions from a computer readable storage medium, such as HDD 1115. Such instructions may be included in software such as an operating system (OS), executable programs, and the like. Information, such as computer instructions and other computer readable data, is transferred between components of computing system 1100 via the system's main data-transfer path. The main data-transfer path may use a system bus architecture 1105, although other computer architectures (not shown) can be used, such as architectures using serializers and deserializers and crossbar switches to communicate data between devices over serial communication paths. System bus 1105 may include data lines for sending data, address lines for sending addresses, and control lines for sending interrupts and for operating the system bus. Some busses provide bus arbitration that regulates access to the bus by extension cards, controllers, and CPU 1110.

Memory devices coupled to system bus 1105 may include random access memory (RAM) 1125 and/or read only memory (ROM) 1130. Such memories include circuitry that allows information to be stored and retrieved. ROMs 1130 generally contain stored data that cannot be modified. Data stored in RAM 1125 can be read or changed by CPU 1110 or other hardware devices. Access to RAM 1125 and/or ROM 1130 may be controlled by memory controller 1120. Memory controller 1120 may provide an address translation function that translates virtual addresses into physical addresses as instructions are executed. Memory controller 1120 may also provide a memory protection function that isolates processes within the system and isolates system processes from user processes. Thus, a program running in user mode may normally access only memory mapped by its own process virtual address space; in such instances, the program cannot access memory within another process' virtual address space unless memory sharing between the processes has been set up.

In addition, computing system 1100 may contain peripheral communications bus 135, which is responsible for communicating instructions from CPU 1110 to, and/or receiving data from, peripherals, such as peripherals 1140, 1145, and 1150, which may include printers, keyboards, and/or the sensors, encoders, and the like discussed herein throughout. An example of a peripheral bus is the Peripheral Component Interconnect (PCI) bus.

Display 1160, which is controlled by display controller 1155, may be used to display visual output and/or presentation generated by or at the request of computing system 1100, responsive to operation of the aforementioned computing program. Such visual output may include text, graphics, animated graphics, and/or video, for example. Display 1160 may be implemented with a CRT-based video display, an LCD or LED-based display, a gas plasma-based flat-panel display, a touch-panel display, or the like. Display controller 1155 includes electronic components required to generate a video signal that is sent to display 1160.

Further, computing system 1100 may contain network adapter 1165 which may be used to couple computing system 1100 to external communication network 1170, which may include or provide access to the Internet, an intranet, an extranet, or the like. Communications network 1170 may provide user access for computing system 1100 with means of communicating and transferring software and information electronically. Additionally, communications network 1170 may provide for distributed processing, which involves several computers and the sharing of workloads or cooperative efforts in performing a task. It is appreciated that the network connections shown are exemplary and other means of establishing communications links between computing system 1100 and remote users may be used.

Network adaptor 1165 may communicate to and from network 1170 using any available wired or wireless technologies. Such technologies may include, by way of non-limiting example, cellular, Wi-Fi, Bluetooth, infrared, or the like.

It is appreciated that exemplary computing system 1100 is merely illustrative of a computing environment in which the herein described systems and methods may operate, and does not limit the implementation of the herein described systems and methods in computing environments having differing components and configurations. That is to say, the concepts described herein may be implemented in various computing environments using various components and configurations.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. An additive manufacturing system, comprising:
a heated print nozzle suitable to deliver at least partially liquefied print material to a print build in a print area;
at least two projected digital masks suitable for providing a pixelization masking of the print area; and
at least one print area heater suitable to deliver heat to at least one of the masked pixels in the print area responsive to at least one controller such that side-to-side bonding of elements of the print build is targeted by the masked pixels, the heating delivered to the masked pixels corresponding to heat delivered by the heated print nozzle to accomplish the targeted side-to-side bonding, the at least one print area heater comprising a collimated heater or a lensed heater.

2. The additive manufacturing system of claim 1, wherein the masked pixels comprise a heating gray scale.

3. The additive manufacturing system of claim 1, wherein the print build is responsive to a print plan of the controller, and wherein the masked pixels are integrated with the print plan.

4. The additive manufacturing system of claim 1, wherein the at least one print area heater comprises at least two print area heaters.

5. The additive manufacturing system of claim 1, wherein the at least one print area heater further comprises a laser.

6. The additive manufacturing system of claim 1, further comprising an alignment of the projected digital masks to eliminate blind spots for masking.

7. The additive manufacturing system of claim 6, wherein the blind spots comprise shadowing from the heated nozzle.

8. The additive manufacturing system of claim 6, wherein the alignment comprises a field-of-view overlap.

9. The additive manufacturing system of claim 1, wherein the delivered heat effectuates inter-layer bonding of the print build.

10. The additive manufacturing system of claim 1, wherein the digital masks comprise digital light processing (DLP) projectors.

11. The additive manufacturing system of claim 1, wherein the digital masks comprise digital micromirroring.

12. The additive manufacturing system of claim 1, wherein the delivered heat comprises a pre-heating.

13. The additive manufacturing system of claim 1, wherein the heating is anticipatorily provided based on knowledge of a build plan of a control algorithm.

14. The additive manufacturing system of claim 1, wherein the delivered heat is additional to a baseline heating of the print area.

15. The additive manufacturing system of claim 14, wherein the baseline heating is directed to previously printed layers of the print build.

16. The additive manufacturing system of claim 15, wherein the baseline temperature is varied as each of the previously printed layers is completed.

17. The additive manufacturing system of claim 1, wherein the delivered heat is proximate to the heated nozzle.

18. The additive manufacturing system of claim 1, wherein the at least two projected digital masks are fixed in place relative to the print area.

19. An additive manufacturing system, comprising:
a heated print nozzle suitable to deliver at least partially liquefied print material to a print build in a print area;
at least two projected digital masks fixed in place relative to the print area, suitable for providing a pixelization masking of the print area; and
at least one print area heater suitable to deliver heat to at least one of the masked pixels in the print area responsive to at least one controller such that side-to-side bonding of elements of the print build is targeted by the masked pixels, the heating delivered to the masked pixels corresponding to heat delivered by the heated print nozzle to accomplish the targeted side-to-side bonding.

20. An additive manufacturing system, comprising:
a heated print nozzle suitable to deliver at least partially liquefied print material to a print build in a print area;
at least two projected digital masks fixed in place relative to the print area, suitable for providing a pixelization masking of the print area; and
at least one print area heater suitable to deliver heat to at least one of the masked pixels in the print area responsive to at least one controller.
